(19) United States
(12) Patent Application Publication
(10) Pub. No.: US 2002/0133815 A1
(43) Pub. Date: Sep. 19, 2002

(54) Receiving apparatus, information processing apparatus and methods thereof

(76) Inventors: Atsushi Mizutome, Kanagawa (JP); Yuichi Matsumoto, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/087,817

(22) Filed: Mar. 5, 2002

(30) Foreign Application Priority Data
Mar. 6, 2001 (JP) 061678/2001

(51) Int. Cl. H04N 7/16

(52) U.S. Cl. 725/9; 725/39

(57) ABSTRACT

The invention is objected to realize searching and selecting information more comfortably even if a desired user profile does not exist in an apparatus, and a receiving apparatus of the present invention includes profile processing means for updating contents of an internal user profile based on a manipulating history, external interface means for inputting an external user profile from outside of the apparatus, selection means for selectively outputting the internal user profile processed by the profile processing means and the external user profile input from the external interface means, and searching means for searching a program among the television broadcasting signals based on the internal user profile or the external user profile, output from the selection means.

### BACKGROUND OF THE INVENTION

1. Field of the Invention

The present invention relates to a receiving apparatus, an information processing apparatus and methods thereof, and more particularly to using and management of a user profile.

2. Related Background Art

Currently, various media deliver information to each home. For example, television, radio or data broadcasting are delivered using ground wave, satellite or CATV (cable television) as a broadcasting wave, and video, audio and information service also are delivered through the Internet or e-mail.

Additionally, digital broadcasting systems are recently spread to deliver a television signal as a digital signal in the broadcasting satellite (hereinafter, referred to as “BS”) broadcasting, communication satellite (hereinafter, referred to as “CS”) broadcasting or CATV. Such systems may employ several hundreds of channels by adopting a compressing/coding technique or digital delivering technique. Therefore, it becomes possible to receive the increased number of image, voice programs and data broadcasting programs rather than the past.

In such a circumstance, among those many programs, there has been recently proposed a technique so that a user may efficiently search and list a desired or purposed program.

For an example, a function of searching a program in a genre the user desires or meeting a keyword by using an electronic program guide (hereinafter, referred to as “EPG”) multiplexed in the digital broadcasting is already designed.

Also, a technique of accumulating a viewing history of a user and then automatically searching and presenting a program according to a preference level of the user obtained based on the viewing history is also under development.

By accumulating various viewing and handling histories of a user, and then preparing information peculiar to the user, or a user profile, with the history information to select, propose and accumulate programs or information based on the user profile as described above, the user may access desired information more comfortably.

Such a user profile is prepared based on a history that the user has used an apparatus.

Therefore, when the apparatus is used for the first time, it is impossible to search or select information based on the user profile because there is no user profile.

### SUMMARY OF THE INVENTION

Under such circumstances, the present invention is designed to solve such problems of the prior art, and an object of the invention is to realize searching and selecting information more comfortably even if a desired user profile does not exist in an apparatus.

In order to accomplish the above object, according to an aspect of the present invention, there is provided a receiving apparatus for receiving television broadcasting signals, comprising a manipulating unit for instructing operation of the receiving apparatus, profile processing means for updating contents of an internal user profile based on a manipulating history of the manipulating unit, external interface means for inputting an external user profile from outside of the receiving apparatus, selection means for selectively outputting the internal user profile processed by the profile processing means and the external user profile input from the external interface means, and searching means for searching a program among the television broadcasting signals based on the internal user profile or the external user profile, output from the selection means.

These and other features and aspects of the present invention will become better understood with regard to the following description for embodiments of the present invention with reference to the following accompanying drawings.

### BRIEF DESCRIPTION OF THE DRAWINGS

FIG. 1 is a block diagram showing a receiving apparatus to which the present invention is applied.

FIG. 2, which is comprised of FIGS. 2A and 2B, is a flowchart for illustrating an operation of the apparatus of FIG. 1.

FIG. 3 shows a display picture screen by the apparatus of FIG. 1.

FIG. 4, which is comprised of FIGS. 4A and 4B, is a flowchart for illustrating another operation of the apparatus of FIG. 1.

FIG. 5 shows another receiving apparatus to which the present invention is applied.

### DETAILED DESCRIPTION OF THE PREFERRED EMBODIMENT

Hereinafter, preferred embodiments of the present invention will be described in detail with reference to the accompanying drawings.

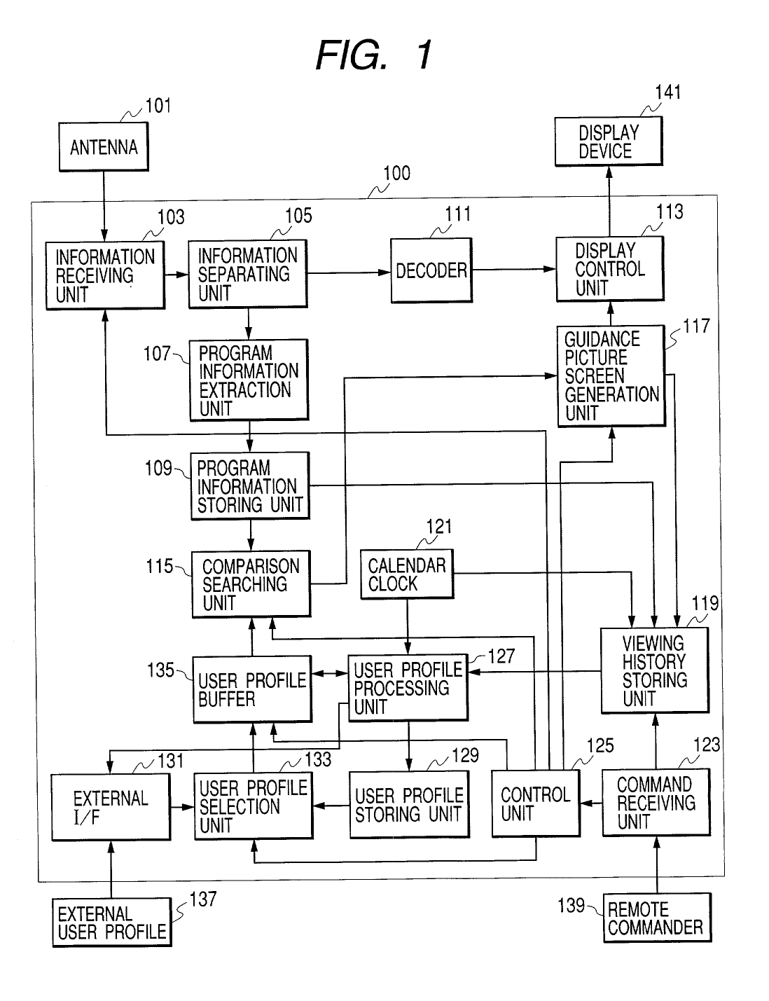

FIG. 1 is a block diagram showing a receiving apparatus to which the present invention is applied.

The receiving apparatus 100 of FIG. 1 receives a broadcasting wave with an antenna 101 and displays image, voice or information (e.g. data broadcasting) related to a channel selected by a user on a display apparatus 141 according to the command from a remote commander 139.

In FIG. 1, an information receiving unit 103 selectively receives an electric wave of frequency conforming to the channel selected by the remote commander 139 from the digital broadcasting signal delivered through the antenna 101, and then executes demodulation, A/D conversion, error correction, and scramble decoding when required, and then generates a data train, which is called transport stream regulated as MPEG2.

An information separating unit 105 separates the transport stream output from the information receiving unit 103 into image data, voice data, data broadcasting data and data attendant on those data, and then outputs the image data, the voice data and the data broadcasting data to a decoder 111 and outputs the attendant data to a program information extraction unit 107.

The program information extraction unit 107 extracts program information, which is multiplexed to television broadcasting signals and is delivered as program-related information, to store in a program information storing unit 109. This program information, for example, includes title, broadcasting date, time (broadcast start and end times), category, sub category, story and performers, which are personally provided from a broadcasting station.

On the other hand, the decoder 111 decodes the image data, the voice data and the data broadcasting-related data respectively, and then outputs data for displaying the image data and the data broadcasting-related data to the display controlling unit 113. And, the voice data is supplied to a voice monitor or an external television monitor, not shown.

And, a user profile storing unit 129 stores an internal user profile generated by a user profile processing unit 127. In this embodiment, the internal user profile is a personal profile for each user who commonly uses the receiving apparatus 100, and is, for example, independently managed for each member of a family. But for some case, it is also possible to manage profiles of members of a family as one family profile.

The internal user profile managed in this embodiment is data including information of preference, life pattern, etc. of the user. And, the user profile processing unit 127 generates the internal user profile based on preset basic user information such as age, sex, residence region, desired genre, etc. of the user as well as a viewing history of how long and which broadcasting media the user has watched at a certain time, and then stores the generated internal user profile in the user profile storing unit 129.

A user profile selection unit 133 selects one of an external user profile 137 input from an external I/F 131 and the internal user profiles stored in the user profile storing unit 129 and then writes the selected one in a user profile buffer 135.

A comparison searching unit 115 comparatively processes program information stored in the program information storing unit 109 and the internal or external user profile stored in the user profile buffer 135 according to a predetermined algorithm so as to search a program conforming to a user preference among programs which are currently or willing to be broadcasted.

A guidance picture screen generating unit 117 generates a picture screen for proposing a program or information, recommended based on the comparison of the comparison searching unit 115, in addition to a common EPG picture screen according to a command of the remote commander 139. At this time, the recommending picture screen may be displayed as a part of the common EPG picture screen. And, it is also preferred to compose the guidance picture screen only with the recommending program.

Data of the generated guidance picture screen is output to the display controlling unit 113.

The display controlling unit 113 is controlled by a control unit 125 commanded by the remote commander 139, and switches or multiplexes a picture screen based on the image data from the decoder 111 and the guidance picture screen from the guidance picture screen generating unit 117 to be displayed in the display apparatus 141.

And, the user may select a desired program or channel by manipulating the guidance picture screen or EPG picture screen displayed on the display apparatus 141 with the remote commander 139. In this embodiment, the remote commander 139 has a power key, a menu key, up/down/right/left cursor keys, an EPG key for instructing display or erasure of the EPG picture screen, a search key for instructing program search, and so on, and the user may instruct operation of the receiving apparatus 100 by manipulating these keys.

A command receiving unit 123 receives a command from the remote commander 139 and outputs the command to the control unit 125 and a viewing history storing unit 119.

The control unit 125 controls functions of each unit according to the command from the remote commander 139 output through the command receiving unit 123.

A calendar clock 121 provides date, a day of the week and time to the viewing history storing unit 119 in connection with the command receiving unit 123. This calendar clock 121 stores information of a program as a viewing history only when it is determined that the user views the program over a predetermined period, based on the output of the calendar clock 121 and the received command from the command receiving unit 123.

The viewing history storing unit 119 stores a table indicating history of program or information that the user has viewed, based on manipulated results of the remote commander 139 from the command receiving unit 123 and program information stored in the program information storing unit 109. Contents in the table include not only basic information such as broadcasting date, day of the week, time, title, category, sub-category etc. but also detailed information particularly provided from the broadcasting station such as producer, produced date, director, players etc.

The user profile processing unit 127 processes data input from the viewing history storing unit 119 and previously-input basic user information such as age, sex, residence, preferred genre etc. of the user, according to a predetermined algorithm so as to generate the internal user profile including information such as user taste or life pattern, and then stores the user profile in the generated user profile storing unit 129.

And, the external user profile 137 is a user profile supplied from outside of the receiving apparatus 100. In this embodiment, a user profile managed by a user connected through an external network such as Internet, a user profile stored in a portable recording medium such as IC card or a user profile stored in, for example, a portable terminal may be used.

The external I/F 131 is an interface to receive the external user profile 137 into the receiving apparatus 100 and may be varied depending on the sort of the external user profile 137. For example, a modem or LAN is used in case that the user profile is laid on the external server, while, if the external user profile is recorded on a portable recording medium such as IC card, a PCMCIA interface or a specific interface for each card is used. In addition, if the external user profile is managed by a mobile phone or PDA, a USB, Bluetooth or infrared interface may be used.

The receiving unit 100 of this embodiment is configured as above, and characterized in that it enables program search using the external user profile in addition to the internal user profile stored in the user profile storing unit 129.

Therefore, the user may search a program conforming to his/her taste by providing the receiving apparatus 100 with his/her own user profile as the external user profile, even when the user handles the receiving apparatus 100 for the first time.

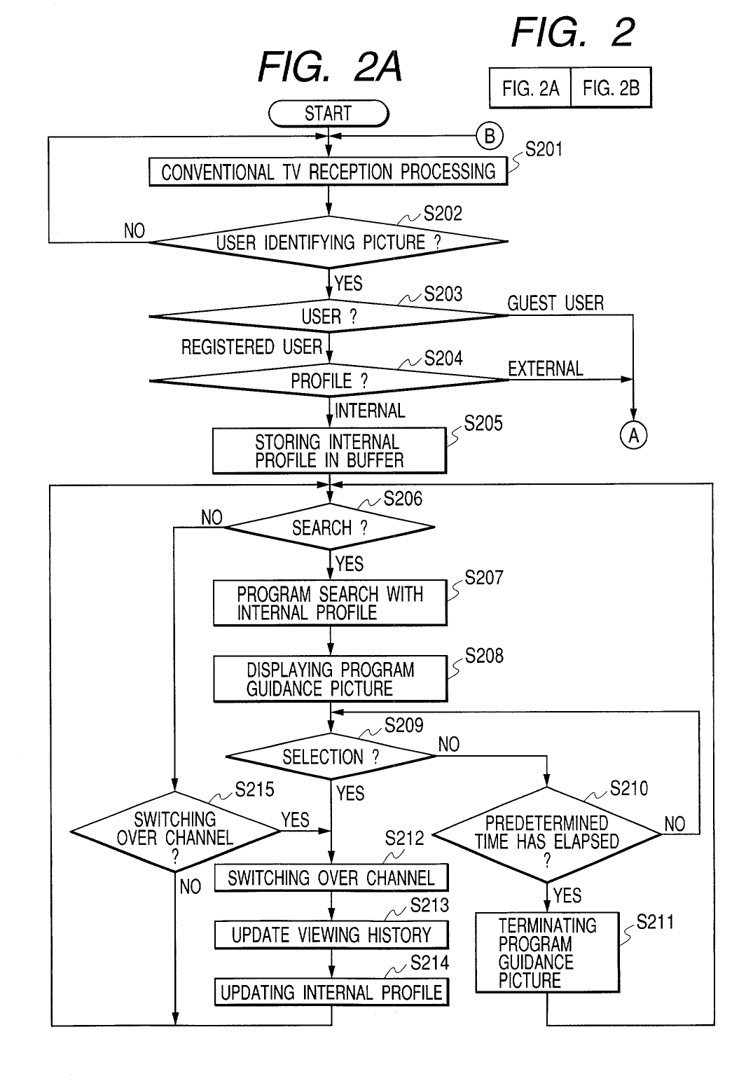

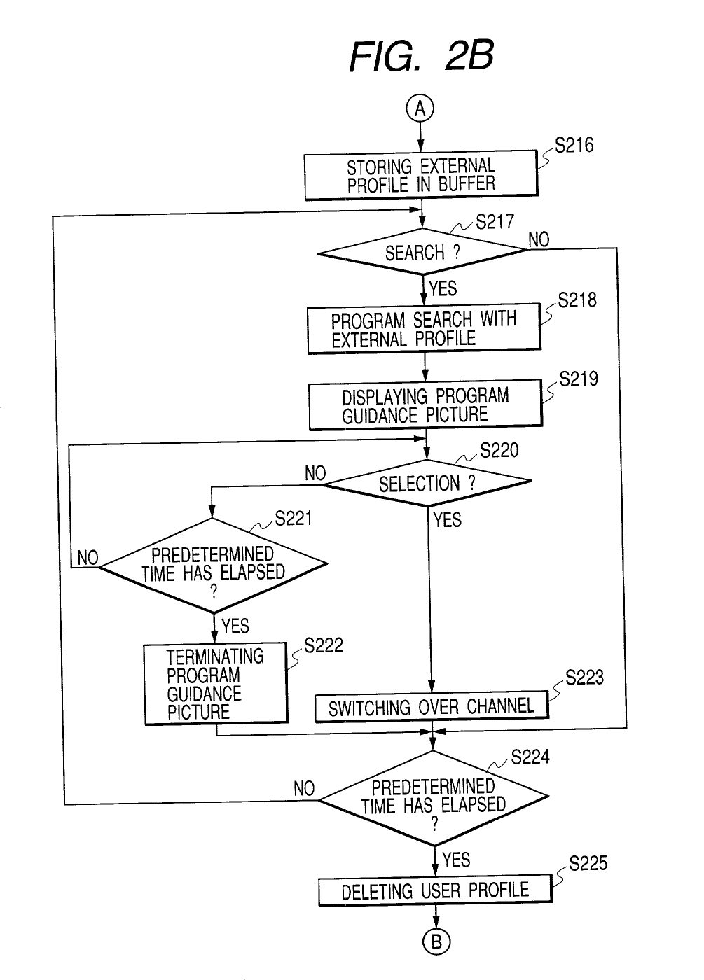

Hereinafter, operations for the external user profile in this embodiment are described in detail with reference to a flowchart of FIGS. 2A and 2B.

FIGS. 2A and 2B are flowcharts for illustrating operation of the receiving apparatus of FIG. 1 on the basis of control of the control unit 125 related to program searching and selecting operations.

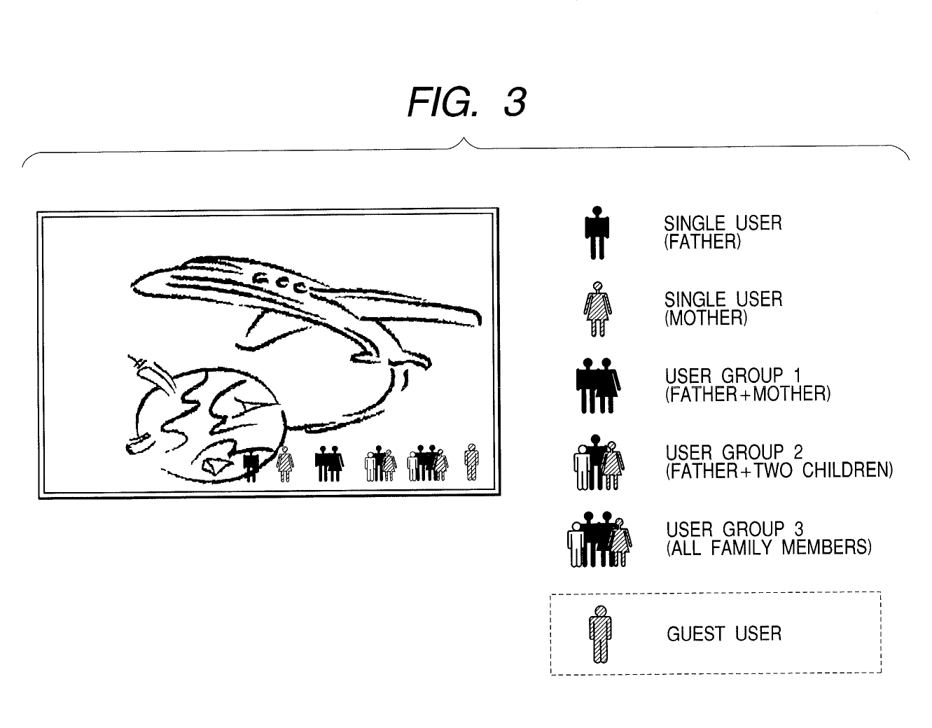

First, when a common television receiving process is executed (step S201), the user manipulates keys to instruct a user identifying picture screen with the remote commander 139 (step S202), and then the guidance picture screen generating unit 117 generates a picture screen for user identification to be displayed on the display apparatus 141 by the display control unit 113 (step S203). The identifying picture screen displayed as above may has, for example, a format of displaying a user name, previously registered in a lower portion of the picture screen or a format of displaying an icon corresponding to each user as shown in FIG. 3.

And, the present embodiment displays a user name “guest” among a user option in addition to the user names registered in the receiving apparatus 100 in advance.

The user informs his/her identity to the control unit 125 by manipulating the cursor keys or enter key or a key corresponding to each icon or option on the remote commander with seeing the user registration picture screen (step S203).

If a registered user name is selected, the guidance picture screen generating unit 117 additionally generates a profile selecting picture screen to be displayed on the display apparatus 141 by the display control unit 113. In this picture screen, the user may select which the internal user profile (because of the registered user, the internal user profile based on the viewing history of the receiving apparatus 100 is stored in the user profile storing unit 129 of course) or the external user profile is to be used (step S204).

If the internal user profile is selected, the control unit 125 controls the user profile selection unit 133 so as to select the user profile selected in the step S203 among the registered user profiles stored in the user profile storing unit 129 and then store the user profile in the user profile buffer 135 (step S205). And, the profile selecting picture screen is erased to display a common television program to stand by ready for receiving a program searching instruction from the remote commander 139 (step S206).

And, if the program search key is selected on the remote commander 139, the comparison searching unit 115 searches programs using the internal user profile (step S207), and then on the basis of the results, the guidance picture screen generating unit 117 generates a guidance picture screen including a recommended program selected based on the search results to be displayed on the display apparatus 141 by the display control unit 113 (step S208).

The user confirms this program guidance picture screen and then selects a desired program by manipulating each key on the remote commander 139 (step S209). And, if a predetermined time is passed without manipulating the program after displaying the guidance picture screen (step S210), the guidance picture screen is erased to display a common television picture screen (step S211).

And, if a desired program is selected on the program guidance picture screen in the step S209, the program guidance picture screen is erased to switch to a channel received by the information receiving unit 103 (step S212). And, if a program is viewed for a certain period as described above, the viewing history storing unit 119 stores the viewing result as a viewing history on the basis of output of the calendar clock 121 (step S213), and the user profile processing unit 127 additionally updates the internal user profile on the basis of the updated viewing history (step S214). And, the user profile processing unit may update the internal user profile just after the viewing history is updated or at midnight or time when the user commonly does not view the television.

And, if there is no instruction by the program search key in the step S206, it is detected that there is a direct channel changing instruction from the remote commander 139, and if there is a channel changing instruction, the process is forwarded to the step S212 (step S215). The procedure after the step S212 is identical to the above-described processes. In addition, though there is no channel changing instruction, the process is forwarded to the step S206 to repeat the above-described procedure.

On the other hand, if the guest user is selected in the step S203 or if the external user profile is selected in the step S204, the control unit 125 controls the user profile selection unit 133 to select the external user profile 137 provided through the external I/F and store in the user profile buffer 135 (Step S216). At this time, the external I/F 131 should be accessible to the external user profile. For example, in case that the external user profile 137 is carried on an IC card, the IC card should be inserted into a PCMCIA slot acting as the external I/F 131.

And, if there is a program searching instruction from the remote commander 139 (step S217), the comparison searching unit 115 searches programs based on he external user profile stored in the user profile buffer 135 (step S218), and with the results, the guidance picture screen generating unit 117 generates a program guidance picture screen including recommended programs selected by the search results to be displayed on the display apparatus 141 by the display control unit 113 (step S219).

The user confirms this program guidance picture screen and then selects a desired program by manipulating the cursor keys or the enter key on the remote commander 139 (step S220). And, if a predetermined time is passed without manipulating the program after displaying the guidance picture screen (step S221), the process is forwarded to the step S222 to erase the program guidance picture screen and the process is forwarded to the step S224.

And, if a desired program is selected on the program guidance picture screen in the step S220, the program guidance picture screen is erased to switch to a channel received by the information receiving unit 103 (step S223).

And, if a predetermined time has elapsed after storing the external user profile in the user profile buffer 135 (step S224), the external user profile stored in the user profile buffer 135 is deleted (step S225).

In the end, after deleting the external user profile in the step S225, it is impossible in this embodiment to search programs using the external user profile without selecting the external user again in the user identifying picture screen to store the external user profile in the user profile buffer 135.

As described above, because the present embodiment enables to search programs based on the external user profile existing outside of the apparatus as well as the internal user profile, it makes it possible to search a program suitable for a taste or life pattern of the user though the user profile is not stored in the receiving apparatus as an internal user profile.

In addition, because the external user profile is deleted in a predetermined time after being stored in the user profile buffer, a profile of a guest user is not left in the receiving apparatus.

In that reason, it may prevent a problem that a registered user abnormally uses an external user profile of a guest, who is not a member of a family using the receiving apparatus 100 as usual, to search undesired programs.

In addition, though it is described that the external user profile is deleted in a predetermined time after being stored in the user profile storing unit 133 in the processes of FIGS. 2A and 2B, it is not limited to that case but, for example, it may be deleted as soon as the program searching process is completed. In this case, the external user profile is stored in the user profile storing unit 133 whenever receiving a program searching instruction from a guest user.

Furthermore, though a history of a guest user of manipulating the receiving apparatus 100 is not included in the external user profile in the processes of FIGS. 2A and 2B, it is also preferable that a guest user may select whether or not to reflect on the external user profile a result of manipulating the receiving apparatus 100 by the guest user.

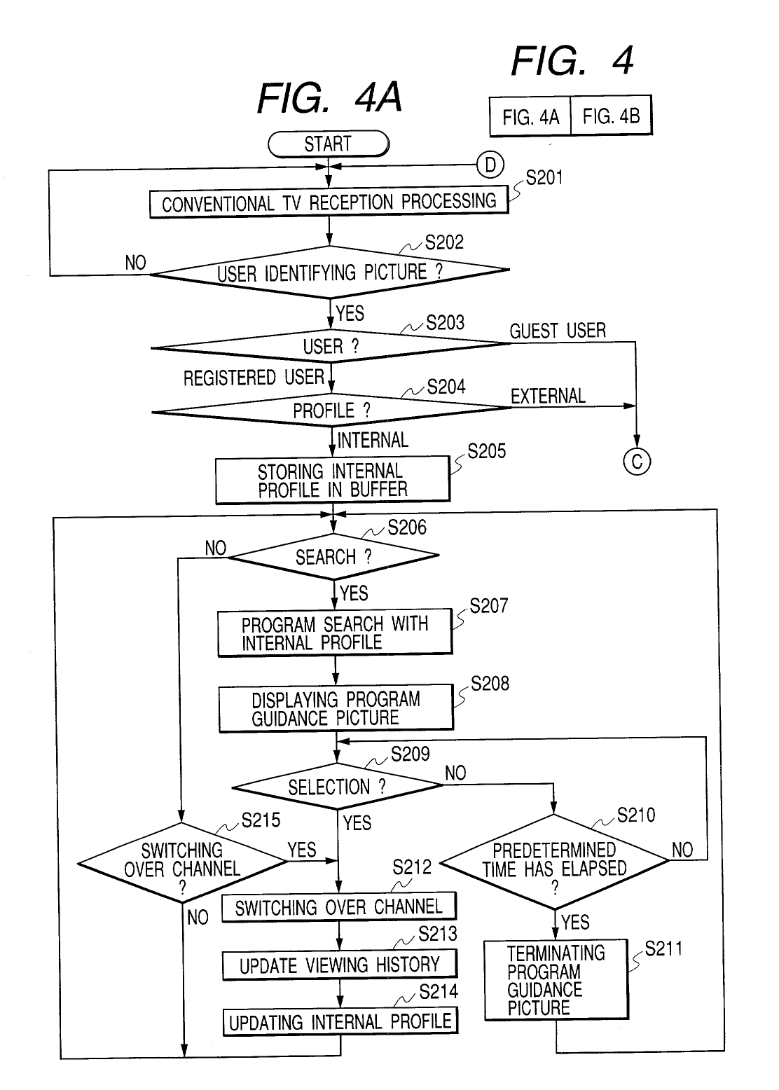

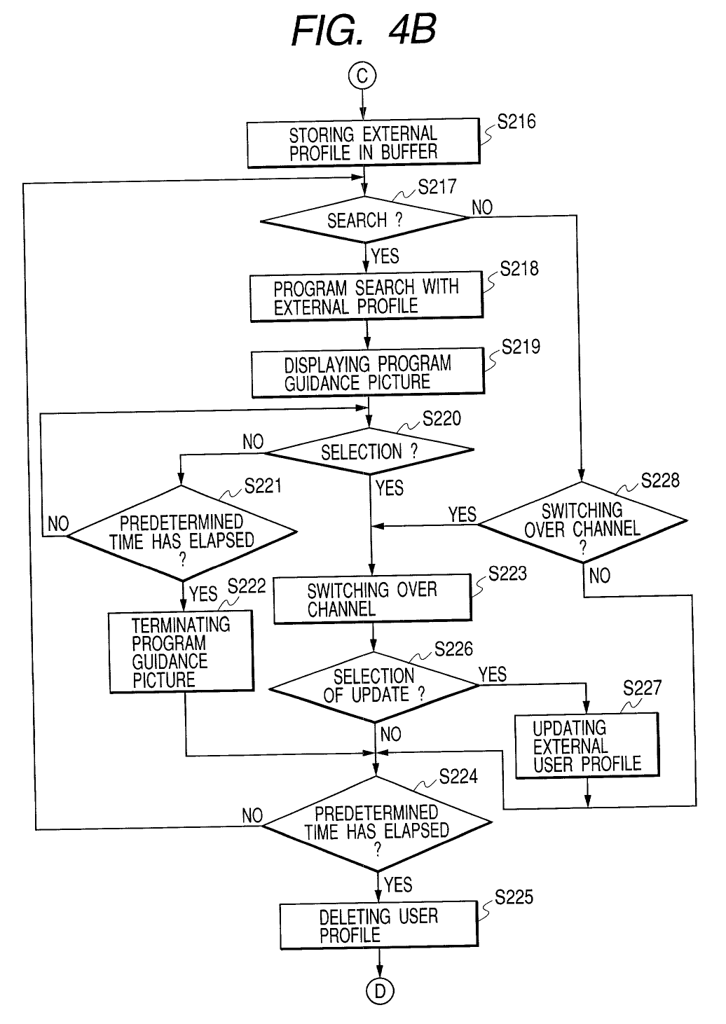

FIGS. 4A and 4B are flowcharts for illustrating the process of reflecting the history of the guest member of manipulating the receiving apparatus 100 as described above. And, in FIGS. 4A and 4B, same process has same reference numeral as FIGS. 2A and 2B, and not described in detail.

Difference from the processes of FIGS. 2A and 2B is the procedure shown in steps S226 to S228. That is, in FIGS. 4A and 4B, after the channel changing process of the step S223, the guidance picture screen generating unit 117 generates a selection picture screen for the profile updating process to be displayed on the display apparatus 141. And, the user selects whether or not to reflect a channel changing result of this time on the external user profile to be updated (step S226).

And, if the updating of the user profile is selected, the user profile processing unit 127 reads out the external user profile stored in the user profile buffer 135 and updates its content by reflecting the channel changing manipulation based on the viewing history information stored in the viewing history storing unit 119 and then records the updated external user profile in the user profile buffer 135 and at the same time outputs the external user profile outside through the external I/F 131.

And, the step S228 of FIG. 4B monitors not only the channel changing caused by the program searching but also whether the user changes the channel by direct key manipulation, and even if the user changes the channel by directly manipulating the keys, the channel changing result of this time may be reflected on the external user profile.

In addition, though it is described that the guest user selects whether or not the external user profile is updated at every time of performing the channel changing in FIGS. 4A and 4B, it is not limited to this case, but it is also preferable that the user may select whether or not the external user profile is updated at the point of determining to use the external user profile in the step S203 or S204.

As described above, in the procedure of FIGS. 4A and 4B also, the program searching process may be performed based on the external user profile. In addition, when the user desires, the external user profile can be updated based on the viewing history of the receiving apparatus 100.

And, because the external user profile is deleted in a predetermined time after being stored in the user profile buffer in the procedure of FIGS. 4A and 4B also, there is not caused the case that the programs are searched based on the external user profile of a guest user by mistake.

Now, a second embodiment of the present invention is described.

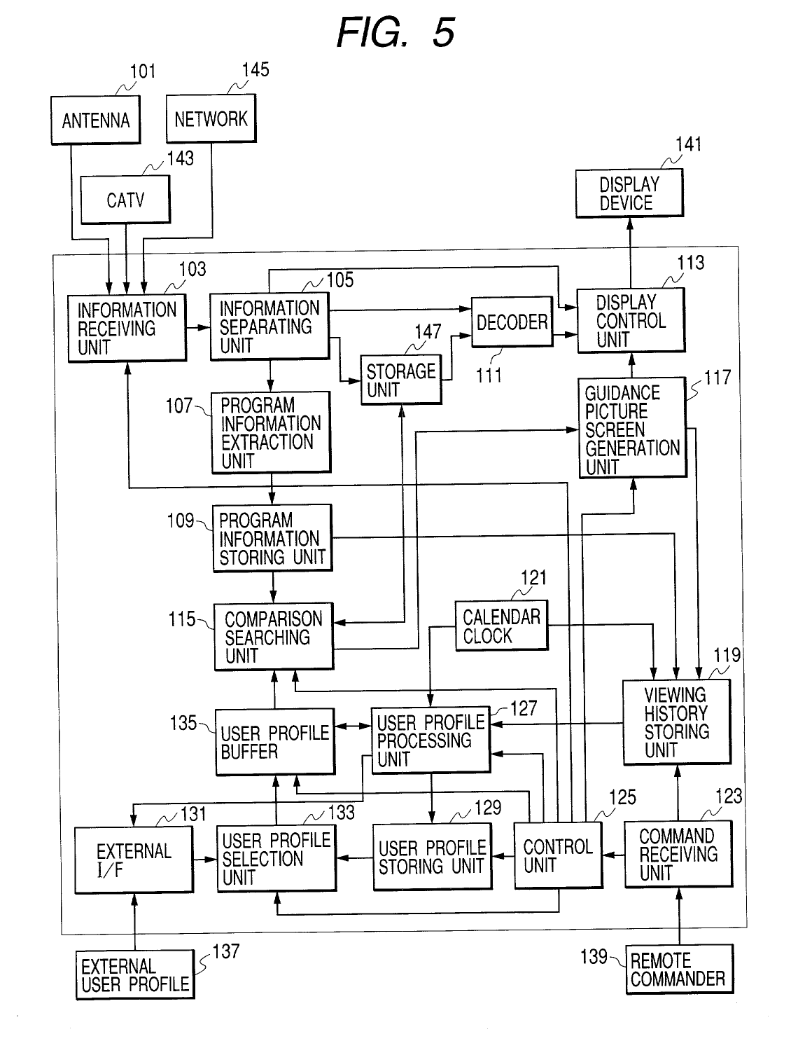

FIG. 5 is a block diagram showing another example of the receiving apparatus 100 to which the present invention is applied. This receiving apparatus 100 of FIG. 5 may receive a broadcasting signal from CATV 143 and image or data information from a network 145 in addition to the television broadcasting from the antenna 101, compared with the receiving apparatus of FIG. 1. In addition, a storage unit 147 is installed to store received signals.

And, as shown in FIGS. 2A, 2B, 4A and 4B, the above embodiment performs the program searching and displays the program guidance picture screen, when receiving a program search instruction from the user.

In the present invention, the program searching is periodically performed at a predetermined interval by the comparison searching unit 115 regardless of the fact that the user is viewing the television broadcasting or not, even when there is no program searching instruction from the user. In addition, in the case that, for example, the power is not supplied to the receiving apparatus 100 at an initiating time of a program which the user habitually watches, it is possible that the storage unit 147 automatically stores a program designated according to a search result from the comparison searching unit 115.

In addition, even when the comparison searching unit 115 is searching programs, the image data and the voice data stored in the storage unit 147 may be inclusively searched in addition to programs of the television broadcasting received by the information receiving unit 103.

That is, when there is a program searching instruction from the user, the comparison searching unit 115 reads out program information of the image and voice data stored in the storage unit 147 in addition to the program information stored in the program information storing unit 109, performs the program searching according to such program information, and then outputs the result to the guidance picture screen generating unit 117.

At this time, the guidance picture screen is displayed so that the recommended programs among the television broadcasting signals received by the information receiving unit 103 and the image and voice data stored in the storage unit 147 are recognizable.

The storage unit 147 may use HDD or magneto-optical apparatus, and stores data output from the information separating unit 105. And, the data stored in the storage unit 147 is decoded in the decoder 111 and output to the display control unit 113.

By installing the storage unit 147 as described above, the range of selection or instruction of programs or information becomes broader as well as it is also possible to control automatic backing up on the basis of the user profile, so extending the range of utilizing the user profile.

In addition, the apparatus of FIG. 5 may receive various information from the CATV circuit 143 or the network 145 such as telephone lines.

In this point, the information received from the network 145 by the information receiving unit 103 is output to the display control unit 113 from the information separating unit 105 without interposing a decoder. The display control unit 113 has functions of interpreting information described in various descriptive languages such as HTML data among information supplied from the network 145 and develops the attached image data to an inner memory.

And, in this embodiment, information of an Internet homepage viewed by a network browser possessed in the display control unit 113, such as a URL or a title, are extracted by the information separating unit 105 and stored through the program information storing unit 109 in the viewing history storing unit 119, and then used to process the user profile by the user profile processing unit 127.

That is, when receiving an instruction of viewing Internet from the remote commander 139, the control unit 125 informs it to the user profile processing unit 127. The user profile processing unit 127 at this time inputs information of the instructed homepage to the viewing history storing unit 119 and updates the user profile.

As described above, the receiving apparatus 100 of this embodiment may generate more precise user profile because of generating the user profile based on the manipulating history when not only receiving the digital television broadcasting but also accessing Internet or other media.

And, the procedures shown in FIGS. 2A, 2B, 4A and 4B are executed similarly in this embodiment.

In addition, though it is described about the case that the present invention is applied to the television broadcasting receiving apparatus in the above embodiment, it is not limited to that case, but the present invention may be easily applied to the case of controlling the information search, selection and operation using the user profile such as a personal computer or various PDAs.

Furthermore, though the decoding process of image or voice data, the searching process using the user profile, the updating process of the user profile, and so on are executed in hardware, but it is also possible that such processes shown in FIGS. 2A, 2B, 4A and 4B are executed in software using a microcomputer.

And, in this case, program codes themselves of the software realize the functions of the above-described embodiment, and the program codes themselves and means for supplying these program codes to a computer, i.e., a storing medium storing such program codes, are constituted in the present invention. As the storing medium storing these program codes, for example, a floppy disk, a hard disk, an optical disk, a magneto-optic disk, a CD-ROM, a magnetic tape, a non-volatile memory card, a ROM and so on may be used.

In addition, the functions described in the above embodiment are executed by executing the program codes supplied from the computer, and even when the functions shown in the above embodiment are executed by OS (an operating system) with which these program codes are operated in the computer and other application software in common, these program codes are included in the embodiment of the present invention.

Furthermore, the present invention also includes the case that the supplied program codes are stored in a memory provided to a function expansion unit connected to a computer or a function expansion board of the computer, a CPU provided in the function expansion board or the function expansion unit then performs a part or all of the real process, and the functions of the above embodiment are executed by such process.

As described above, by using the present invention, it becomes possible to comfortably search or select information even when a desired user profile does not exist in the apparatus.

Many widely different embodiments of the present invention may be constructed without departing from the spirit and scope of the present invention. It should be understood that the present invention is not limited to the specific embodiments described in the specification, except as defined in the appended claims.

What is claimed is:

1. A receiving apparatus for receiving television broadcasting signals, comprising:
a manipulating unit for instructing operation of the receiving apparatus;
profile processing means for updating contents of an internal user profile based on a manipulating history of said manipulating unit;
external interface means for inputting an external user profile from outside of said receiving apparatus;
selection means for selectively outputting the internal user profile processed by said profile processing means and the external user profile input from said external interface means; and
searching means for searching a program among the television broadcasting signals based on the internal user profile or the external user profile, output from said selection means.

2. An apparatus according to claim 1, further comprising:
picture screen generating means for generating a guidance picture screen according to a search result of said searching means; and
display control means for outputting an image data representing the guidance picture screen generated by said picture screen generating means to a display apparatus.

3. An apparatus according to claim 1, wherein said searching means includes:
storing means for storing the internal user profile and the external user profile output from said selection means; and
control means for controlling to write or read out the internal user profile and the external user profile to/from said storing means.

4. An apparatus according to claim 3,
wherein said searching means has a first mode for storing the internal user profile selected by said selection means in said storing means and performing search based on the internal user profile stored in said storing means and a second mode for storing the external user profile selected by said selection means in said storing means and performing search based on the external user profile stored in said storing means, and
wherein said control means controls said storing means to delete the external user profile stored in said storing means in a predetermined time after storing the external user profile selected by said selection means in the second mode.

5. An apparatus according to claim 3,
wherein said searching means has a first mode for storing the internal user profile selected by said selection means in said storing means and performing search based on the internal user profile stored in said storing means and a second mode for storing the external user profile selected by said selection means in said storing means and performing search based on the external user profile stored in said storing means, and
wherein said control means controls said storing means to delete the external user profile stored in said storing means, in response to completion of the searching by said searching means in the second mode.

6. An apparatus according to claim 1,
wherein said profile processing means does not update contents of the external user profile.

7. An apparatus according to claim 1, further comprising:
setting means for setting a user; and
control means for controlling said selection means to select the internal user profile when a predetermined user is set by said setting means and select the external user profile when a user except the predetermined user is set.

8. An apparatus according to claim 7, further comprising a user profile storing unit for storing an internal user profile of the predetermined user, and
wherein said selection means selectively outputs the external user profile and the internal user profile stored in said user profile storing unit.

9. An apparatus according to claim 1, further comprising storage means for storing the television broadcasting signals received by said receiving means, and
wherein said storage means stores program data selected based on the search result of said searching means.

10. An apparatus according to claim 9,
wherein said searching means additionally searches programs among the data stored in said storage means.

11. An apparatus according to claim 1, further comprising instructing means for instructing whether or not to update contents of the external user profile on the basis of the manipulating history,
wherein said profile processing means additionally updates contents of the external user profile based on the manipulating history according to the profile updating instruction of said instructing means.

12. An apparatus according to claim 11,
wherein said external interface means additionally outputs the external user profile having contents updated by said profile processing means outside of said apparatus.

13. An information processing apparatus for processing information based on a user profile, comprising:
profile processing means for generating an internal user profile according to a processing operation of said information processing apparatus;
profile inputting means for inputting an external user profile from outside of said information processing apparatus;
selection means for selectively outputting the internal user profile obtained by said profile processing means and the external user profile input by said profile inputting means; and
information processing means for processing information based on the internal user profile or the external user profile, output from said selection means.

14. An apparatus according to claim 13,
wherein said information processing means selects the information based on the internal user profile or the external user profile, output from said selection means.

15. An apparatus according to claim 13,
wherein said information processing means searches the information based on the internal user profile or the external user profile output from said selection means.

16. An apparatus according to claim 13,
wherein said information processing means compares the internal user profile or the external user profile, output from said selection means with the information.

17. An apparatus according to claim 13, further comprising receiving means for receiving information transmitted from outside of said apparatus,
wherein said information processing means processes the information received by said receiving means based on the internal user profile or the external user profile, output from said selection means.

18. An apparatus according to claim 13, wherein said information processing means includes:
storing means for storing the internal user profile and the external user profile, output from said selection unit; and
control means for controlling to write or read out the internal user profile and the external user profile to/from said storing means.

19. An apparatus according to claim 18,
wherein said searching means includes a first mode for storing the internal user profile selected by said selection means and processing information based on the internal user profile stored in said storing means and a second mode for storing the external user profile selected by said selection means and processing information based on the external user profile stored in said storing means, and
wherein said control means controls said storing means to delete the external user profile stored in said storing means in a predetermined time after storing the external user profile selected by said selection means in the second mode.

20. An apparatus according to claim 18,
wherein said searching means includes a first mode for storing the internal user profile selected by said selection means and processing information search based on the internal user profile stored in said storing means and a second mode for storing the external user profile selected by said selection means and processing information based on the external user profile stored in said storing means, and
wherein said control means controls said storing means to delete the external user profile stored in said storing means in response to completion of the processing of information based on the external user profile by said information processing means in the second mode.

21. An apparatus according to claim 13, further comprising storage means for storing information, and
wherein said information processing means processes the information stored in said storage means.

22. A method of receiving television broadcasting signals by a receiving apparatus, comprising:
a profile processing step of changing contents of an internal user profile based on a manipulating history of said apparatus;
an inputting step of inputting an external user profile from outside of said apparatus;
a selection step of selectively outputting one of the internal user profile and the input external user profile; and
a searching step of searching programs among the television broadcasting signals based on the internal user profile or the external user profile.

23. A method according to claim 22, wherein said searching step includes:
a storing step of storing the internal user profile and the external user profile output in said selection step; and
a control step of controlling to write and read out the internal user profile and the external user profile in said storing step.

24. A method according to claim 23,
wherein the searching step includes a first mode for storing the selected internal user profile in said storing step and performing search based on the stored internal user profile and a second mode for storing the selected external user profile in said storing step and performing search based on the stored external user profile, and
wherein said control step controls said storing step to delete the stored external user profile in a predetermined time after storing the external user profile selected in the second mode.

25. A method according to claim 23,
wherein said searching step includes a first mode for storing the selected internal user profile in said storing step and performing search based on the stored internal user profile and a second mode for storing the selected external user profile in said storing step and performing search based on the stored external user profile, and
wherein said control step controls the storing step to delete the stored external user profile in response to completion of the searching in said searching step in the second mode.

26. A method according to claim 22,
wherein said profile processing step does not update contents of the external user profile.

27. A method according to claim 22, further comprising:
a setting step of setting a user; and
a control step of controlling said selection step to select the internal user profile when a predetermined user is set by said setting step and select the external user profile when a user except the predetermined user is set.

28. A method according to claim 27, further comprising a user profile storing step of storing an internal user profile of the predetermined user, and
wherein said selection step selectively outputs the external user profile and the internal user profile stored in said user profile storing step.

29. A method according to claim 23, further comprising a storage step of storing the television broadcasting signals received by said receiving step, and
wherein said storage step stores program data selected based on the search result of said searching step.

30. A method according to claim 29,
wherein said searching step additionally searches programs among the data stored by said storage step.

31. A method according to claim 22, further comprising an instructing step of instructing whether or not to update contents of the external user profile on the basis of the manipulating history, and
wherein said profile processing step additionally updates contents of the external user profile based on the manipulating history according to the profile updating instruction of said instructing step.

32. A method according to claim 31, further comprising an outputting step of outputting the external user profile having contents updated by said profile processing step to the external of said apparatus.

33. A method of processing information based on a user profile by an information processing apparatus, comprising:
a profile processing step of generating an internal user profile according to a processing operation of said apparatus;
a profile inputting step of inputting an external user profile from outside of said apparatus;
a selection step of selectively outputting one of the internal user profile and the input external user profile; and
an information processing step of processing information based on the selected one of the internal user profile or the external user profile.

34. A storing medium which stores program to carry out the method mentioned in any one of claims 22 to 33 by using a computer.
